(19) United States
(12) Patent Application Publication
(10) Pub. No.: US 2006/0204267 A1
(43) Pub. Date: Sep. 14, 2006

(54) Image forming apparatus

(75) Inventor: Masaru Watanabe, Osaka (JP)

Correspondence Address: ROSSI, KIMMS & McDOWELL LLP., P.O. BOX 826, ASHBURN, VA, 20146-0826, US

(73) Assignee: Kyocera Mita Corporation, Chuo-ku (JP)

(21) Appl. No.: 11/335,850

(22) Filed: Jan. 19, 2006

(30) Foreign Application Priority Data
Jan. 20, 2005 (JP) 2005-13411

(51) Int. Cl. G03G 15/00

(52) U.S. Cl. 399/74

(57) ABSTRACT

A toner density on a toner image carrier means such as an intermediate transfer belt is accurately measured, even if a durability of the toner image carrier means is changed. It is assumed that output dark voltages from said first and second photo-detector means are P0 and S0, respectively; back-ground voltages from said first and second photo-detector means are Pg and Sg, respectively, when any toner is not attached on said toner image carrier means; measured voltages from said first and second photo-detector means are P and S, respectively, when said toner image was formed on said toner image carrier means. Then, a coverage rate CR and a durability X are calculated by the following formulae.
CR=1−((P−P0)−(S−S0))/((Pg−P0)−(Sg−S0)),
X=A×(1−(Sg−S0)/((Pg−P0)). Further, the toner density is obtained on the basis of the corrected CR by using durability X as a parameter.

### BACKGROUND OF THE INVENTION

1. Field of the Invention

The present invention relates to an image forming apparatus which comprises a measuring unit for measuring a toner density on toner image carrier means for carrying the toner image.

2. Description of the Related Art

In general, an image density is corrected by feeding back image forming conditions such as a development bias voltage in response to a measurement result of a toner density, for example, on the image carrier means such as an intermediate transfer belt. When the toner density is to be measured on the toner image carrier means, a measurement light from a light source is projected on the toner image on the toner image carrier means. A part of the measurement light (a first reflected light) is reflected by the toner and other part (a second reflected light) is reflected by the surface of the toner image carrier means. They are incident in photo-detectors for outputting detecting signals by detecting the first and second reflected lights.

When the toner density is high, the detected light is decreased, because the second reflected light is shielded by the toner. On the other hand, when the toner density is low, the detected light is increased, because the second reflected light is increased. Thus, the toner density attached on the toner image carrier means can be measured by the detected signals from the photo-detectors.

Here, the toner used in the image forming apparatus contains toner component itself and other components such as polishing agent. Further, the surface state on the toner image carrier means changes, according to a time period of use of the image forming apparatus, thereby changing the first and second photo-detector outputs for the first and second reflected lights, respectively. As a result, the toner density cannot be precisely measured and the image density cannot be precisely corrected.

In order to overcome that disadvantage, there is disclosed in JP2004-177608A that a light from a light emitting element is polarized by a polarizing filter and the reflected light from the toner image is decomposed by a polarization separating prism into a first light polarized to the same direction of the incident light and a second light polarized to other direction. Then, a pair of photo-detectors detects the first and second lights and outputs detection signals for the first and second lights, thereby measuring the toner density on the toner image carrier means, on the basis of a difference between the first detection signal and the second detection signal. Concretely, the first and second detection signal levels are adjusted to be equal, when a prescribed quantity of toner is attached on the toner image carrier means. Further, a standard difference is decided by a difference between the two detection signals, when no toner is attached on the toner image carrier means. Thus, the toner density on the toner image carrier means is obtained on the basis of a correction output value which is obtained by correcting, in accordance with the above-mentioned standard difference, the difference of the two detection signals.

However, the measured toner density becomes shifted from the actual toner density, when the surface of the toner image carrier means is greatly changed in response to a period of time of use, particularly to a long period of time of use. The long term surface change of the toner image carrier means depends upon its material quality.

Therefore, the conventional toner density measurement has a disadvantage that the measured toner density measured by the detected signals from the toner density measurement unit is shifted from the actual toner density, even if the toner is sufficiently attached on the toner image carrier means. As a result, the image density cannot be precisely corrected by the feed-back control on the basis of the measured toner density shifted from the actual toner density.

### SUMMARY OF THE INVENTION

An object of the present invention is to provide an image forming apparatus with a toner density measuring unit which can accurately measure the toner density on the toner image carrier means, in response to the durability of the toner image carrier means.

An image forming apparatus of the present invention is provided with toner image carrier means for carrying a toner image which is transferred onto a recording medium. The image forming apparatus includes a toner density measuring unit for measuring a toner density of toner attached on the toner image carrier means, in response to a reflected light reflected from the toner image carrier means, when a measurement light is projected on the toner image carrier means.

Further, the toner density measuring unit comprises: light projection means for projecting a first polarized light on the toner image carrier means at an angle inclined to a normal direction of the toner image carrier means; polarization separating means which is positioned at an opposite side of the light projecting means regarding the normal direction of the surface of the toner image carrier and which separates the polarizations of the reflected light into the first polarization and a second polarization which is different from the first polarization; a first and second photo-detector means for detecting the first and second polarization lights and outputting a first and second outputs; control means for obtaining the toner density on the toner image carrier means, in response to a difference between the first output and the second outputs.

Next, the operation of the image forming apparatus of the present invention is explained. The first output is adjusted to be equal to the second output, when a prescribed quantity of the toner is attached on the toner image carrier means; output dark voltages from the first and second photo-detector means are measured to be P0 and S0, respectively, after the output adjustment; back-ground voltages from the first and second photo-detector means are measured to be Pg and Sg, respectively, when any toner is not attached on the toner image carrier means; voltages from the first and second photo-detector means are measured to be P and S, respectively, when the toner image was formed on the toner image carrier means.

Then, the control means obtains a coverage rate CR defined by:
CR=1−((P−P0)−(S−S0))/((Pg−P0)−(Sg−S0)),
obtains a durability X of the toner image carrier means defined by:
X=A×(1−(Sg−S0)/((Pg−P0)),
corrects the coverage rate CR by using the durability X and obtains the toner density on the basis of corrected coverage rate CCR defined by:
CCR=B×(1−((P−P0)−(S−S0))/((Pg−P0)−(Sg−S0))),
where B is a correction factor by using a parameter X.

CCR may be further corrected, in order to suppress toner density variation due to the variation of output adjustment and variation of the setting up of the toner density measuring apparatus. In this case, CCR is replaced by NCCR.
NCCR=(1+(B−1)×L)×(1−((P−P0)−(S−S0))/((Pg−P0)−(Sg−S0)))

Further, in order to correct an output level of the second photo-detector means, a constant K in a range of (0, 1) excluding 0 is introduced and the CR, X, CCR and NCCR are replaced by CRK, XK, CCRK and NCCRK:

$$CRK = 1 - ( ( P - P0 ) - ( S - S0 ) \times K ) / ( ( Pg - P0 ) - ( Sg - S0 ) \times K )$$

$$XK = A \times ( 1 - ( Sg - S0 ) \times K / ( ( Pg - P0 ) ) \\ CCRK = B \times ( 1 - ( ( P - P0 ) - ( S - S0 ) \times K ) / ( ( Pg - P0 ) - ( Sg - S0 ) \times K ) ) \\ NCCRK = ( 1 + ( B - 1 ) \times L ) \times ( 1 - ( ( P - P0 ) - ( S - S0 ) \times K ) / ( ( Pg - P0 ) - ( Sg - S0 ) \times K ) )$$

As explained above, in the present invention, the coverage rate CR is obtained, the durability X of the toner image carrier means is obtained and the corrected coverage rate CCR is obtained by using the durability X as a parameter, thereby obtaining the toner density. As a result, the present invention has an advantage that the toner density can be always precisely obtained, on the basis of the corrected coverage rate CCR, even if the durability is changed, i.e., even if the toner image carrier means is used for a long time period.

### BRIEF DESCRIPTION OF THE DRAWINGS

FIG. 1 is a cross sectional view of an intermediate transfer belt of the image forming apparatus of the present invention.

FIG. 2 is a conceptional view of an exemplary toner density measuring unit of the image forming apparatus of the present invention, wherein an appropriate quantity of toner is attached on the intermediate transfer belt.

FIG. 3 is a conceptional view of the exemplary toner density measuring unit of the image forming apparatus of the present invention, wherein no toner is attached on the intermediate transfer belt.

FIG. 4 is a conceptional view of an exemplary toner density measuring unit of the image forming apparatus of the present invention, wherein the toner is attached on the intermediate transfer belt.

FIG. 5 shows graphs showing relationships between a coverage rate and the actual toner density.

FIG. 6 is a graph showing a relationship between a corrected coverage rate and the actual toner density.

FIG. 7 is a chart showing relationships between the corrected coverage rate CCR and the toner densities, calculated by equation (3) on the basis of a target coverage rate P.

FIG. 8 is a chart showing relationships between the newly corrected coverage rate NCCR and the toner densities, calculated by equation (4) on the basis of the target coverage rate P.

### DETAILED DESCRIPTION OF THE PREFERRED EMBODIMENTS

Preferred embodiments are explained, referring to the drawings. Regarding the elements described in the preferred embodiments, their sizes, material qualities, shapes, relative arrangements and so on should not be understood to limit the present invention as they are, even if they are concretely specified.

Here, explained is the measurement of the toner density on the intermediate transfer belt which is one of the toner image carrier means in the image forming apparatus. The present invention is applicable not only for the intermediate transfer belt, but also for a transfer belt and further for other type of the toner image carrier means such as an a-Si photo-receptor drum.

In the image forming apparatus provided with the intermediate transfer belt, for example, not-shown four photoreceptor drum units (for example, photo-receptor drums for yellow (Y), cyan (C), magenta (M), black (BK)) are arranged, thereby exposing each photoreceptor drum corresponding to each image data, forming an electrostatic latent image for each color, developing each latent image by a development apparatus for each color and obtaining a toner image for each color.

Further, those toner images are sequentially transferred to the intermediate transfer belt (a primary transfer), then transferred (a secondary transfer) to a recording medium such as a paper at a secondary transfer position by a secondary transfer roller. Thus, a color image is formed on the paper. Then, the color image on the paper is fixed by a fixing unit and the paper is sent out to a paper tray.

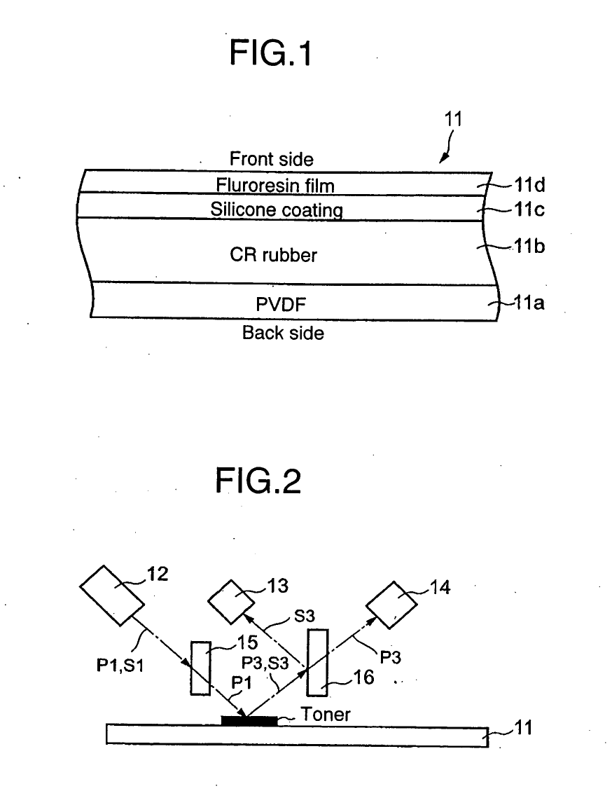

As shown in FIG. 1, the intermediate transfer belt 11 is a multi-layered rubber belt, wherein a PVDF layer (100 μm) 11a at the lowermost layer (back side), a CR rubber layer (500 μm) 11b, a silicone sheet (5 μm) 11c and a fluororesin film (5 μm) 11d are layered in this order. Thus, the fluororesin film 11d becomes the front surface side of the intermediate transfer belt.

When prescribed times of the printings (image formations) are executed in the image forming apparatus, a monitoring toner image (toner patch) for each color and for each density is formed on the intermediate transfer belt 11, the toner densities of the toner patches are measured, thereby correcting the image density by controlling image forming conditions such as a development bias voltage, on the basis of the measured toner patch densities.

Referring to FIG. 2, the toner density measuring unit for measuring the toner density on the intermediate transfer belt 11 comprises: a light emitting element 12 such as an LED for projecting a measurement light on the surface of the intermediate transfer belt 11; a first and second photodetectors 14 and 13, respectively for detecting the lights reflected from the intermediate transfer belt. Further, there is arranged a polarization filter 15 between the light emitting element 12 and the intermediate transfer belt 11. The polarization filter 15 transmits only the P polarization light.

Here, it is assumed that a sufficient (appropriate) quantity of the toner is transferred on the intermediate transfer belt 11. When the measurement light from the light emitting element 12 is projected onto the intermediate transfer belt 11, the S polarization component S1 of the measurement light which includes both the S polarization component S1 and P polarization component P1 is cut out by the P polarization filter 15. Therefore, the measurement light P1 through the P polarization filter 15 is entirely reflected by the intermediate transfer belt 11. Thus, when a sufficient quantity of the toner is transferred on the intermediate transfer belt 11, the measurement light P1 is entirely reflected by the toner, without transmitting the toner layer (without reaching the surface of the intermediate transfer belt 11).

Here, the light reflected by the toner has the P polarization component P3 and the S polarization component S3. The polarization separating prism 16 is positioned at the reflection side (opposite side of the incident side of the measurement light, i.e., the opposite side of the incident side regarding the normal direction to the surface of the intermediate transfer belt 11), thereby separating the reflected light into the P component and the S component. The P component P3 is incident to the first photo-detector 14, while the S component S3 is incident to the second photo-detector 13.

Thus, the first and second photo-detector 14 and 13 output a first and second photoelectric conversion signals, respectively, which are digitized by AD converter and are outputted to a not-shown control apparatus.

The not-shown control apparatus adjusts the output levels (gains) of the first and second photo-detectors in such a manner that they are equal to each other, when the sufficient quantity of the toner is attached on the intermediate transfer roller 11. In other words, if the appropriate (sufficient) quantity of the toner is attached on the intermediate transfer belt 11, i.e., if a lot of the toners are attached in a solid image manner, the first output signal is adjusted to be equal to the second output signal. Further, after completing the output adjustment for the first and second photo-detectors 14 and 13, respectively, the output dark voltages from the first and second photo-detectors 14 and 13, respectively, are measured to be P0 and S0, respectively.

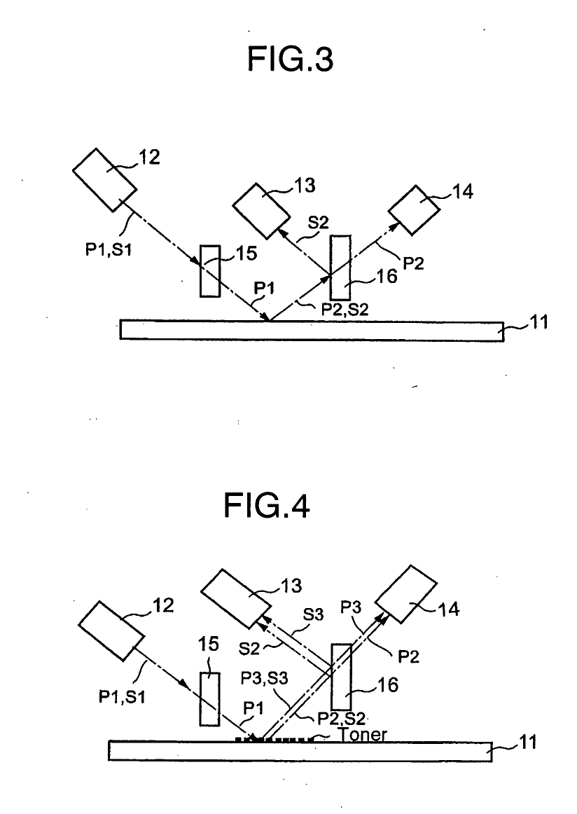

Further, referring to FIG. 3, if the toner image is not formed (the toner image is not transferred) on the intermediate transfer belt 11, the S component light S1 of the incident measurement light which has both the S component light S1 and the P component light P1 is cut out by the polarization filter 15. Thus, only the P component light P1 is projected onto the surface of the intermediate transfer belt 11 and is reflected by the surface of the intermediate transfer belt 11, in response to its surface shape or its surface roughness. As a result of the reflection of P component light P1, the reflected light has the P and S component lights.

Here, the P and S component lights of the above-mentioned reflected light are set to be P2 and S2, respectively which are separated by the polarization separation prism 16, thereby the S2 light being detected by the second photo-detector 13 and the P2 light P2 being detected by the first photo-detector 14.

The first and second photo-detector 14 and 13 detect the P2 and S2 lights, respectively, and output a first and second photoelectric conversion signals of the P2 and S2 lights, respectively. The two photoelectric conversion signals are digitized by AD converter and are outputted to the not-shown control apparatus. The not-shown control apparatus sets up standard value ((Pg−P0)−(Sg−S0)), where Pg and Sg are the first and second photoelectric conversion output signals, respectively, when the toner is not attached. Namely, those two output signals are background signals Pg and Sg. After completing the already explained output adjustment (equalization) and the above-mentioned standard value setup, the toner density on the intermediate transfer belt is measured.

Referring to FIG. 4, it is assumed that the toner patch is formed on the intermediate transfer belt 11. The S component of the incident measurement light is cut out by the P polarization filter 15 and therefore only the P component light of the incident measurement light is projected onto the toner. When the toner quantity in the toner patch image is insufficient, a part of the P1 light incident to the toner is reflected and other part transmits the toner and is reflected by the surface of the intermediate transfer belt 11.

The P1 light reflected by the surface of the intermediate transfer belt 11 has the P and S components P2 and S2, respectively, caused by the reflection. Thus, the P2 and S2 polarization are separated by the polarization separating prism 16, thereby the P2 polarization light being detected by the first photo-detector 14 and the S polarization light being detected by the second photo-detector 13.

Similarly, the polarizations of the light reflected by the toner are separated by the polarization separation prism 16, thereby the P3 polarization light being detected by the first photo-detector 14 and the S3 polarization light being detected by the second photo-detector 13.

As already mentioned, the first and second photo-detector 14 and 13 output a first and second photoelectric conversion signals, respectively, which are digitized by AD converter and are outputted to the not-shown control apparatus. The not-shown control apparatus obtains a measured output value ((P−P0)−(S−S0)), where P and S are the first and second photoelectric conversion output signals, respectively. Further, the not-shown control apparatus obtains a correction value “C”;
C=((P−P0)−(S−S0))/((Pg−P0)−(Sg−S0))

Finally, the not-shown control apparatus obtains the coverage rate “CR” which is defined by the following formula (1);
CR=1−C (1)

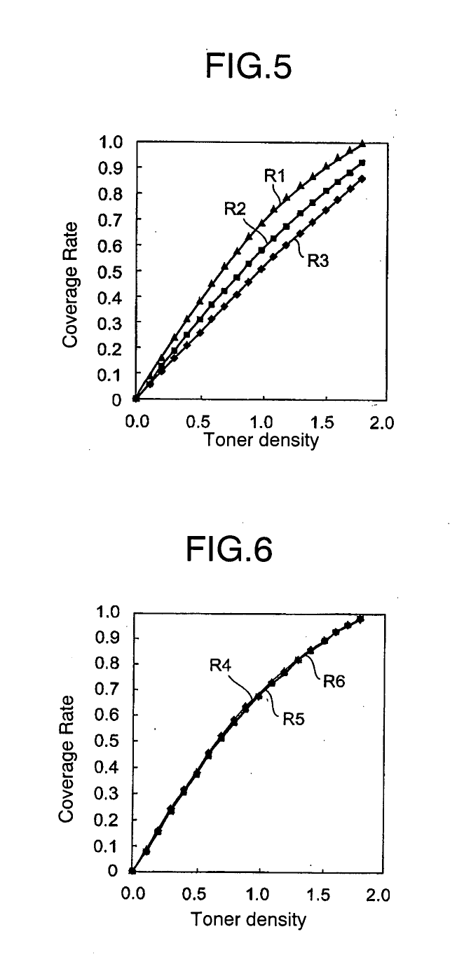

FIG. 5 shows graphs showing relationships between the coverage rate “CR” as defined by formula (1) and the actual toner density. The curve R1 is a curve showing a relation between the “CR” and the actual toner density, when the intermediate transfer belt is new. The curve R2 is a curve showing a relation between the “CR” and the actual toner density, after the intermediate transfer belt 11 was used for a certain period of time. The curve R3 is a curve showing a relation between the “CR” and the actual toner density, after the intermediate transfer belt 11 was further used over the certain time period of the curve R2. FIG. 5 shows the relationships between three color (lumped together) coverage rate “CR” and the actual toner density.

As shown in FIG. 5, the relationship between “CR” and the actual toner density changes, as the time period of use of the intermediate transfer belt 11 becomes longer. Therefore, the image density cannot be precisely controlled, due to the above-mentioned relationship change as shown in FIG. 5. Particularly, the above-mentioned relation is changed, due to whitening of the surface of the intermediate transfer belt 11 made of a rubber.

Here, the durability “X” of the intermediate transfer belt 11 is defined by the following formula (2);
X=A×(1−(Sg−S0)/((Pg−P0)) (2),
where “A” is a constant which is determined by ((Pg−P0)−(Sg−S0)), when (Pg−P0)=A. “A” of the rubber belt as shown in FIG. 1 is 0.3.

Now, it is understood that the durability “X” is related to the changes as shown by the curves R1, R2 and R3. The durability “X” is 0.223 in the curve R1, “X” is 0.192 in the curve R2 and “X” is 0.149 in the curve R3. The durability “X” is lowered, as the intermediate transfer belt is used for a longer time period.

Further, the corrected coverage rate “CCR” is defined by following formula (3);
CCR=B×(1−((P−P0)−(S−S0))/((Pg−P0)−(Sg−S0))) (3),
where “B” is a correction factor having the parameter “X”.

FIG. 3 are graphs showing relationships between the corrected coverage rate “CCR” and the actual toner density. The curve R4 is a curve when the durability “X” is 0.223, the curve R5 is a curve when the durability “X” is 0.192 and the curve R6 is a curve when the durability “X” is 0.149. FIG. 6 shows the relationships between three color (lumped together) corrected coverage rate “CCR” and the actual toner density.

As shown in FIG. 6, the relationship between “CCR” and the actual toner density hardly changed, even if the durability “X” is changed. Therefore, the image density can be precisely controlled by using the corrected coverage rate “CCR”.

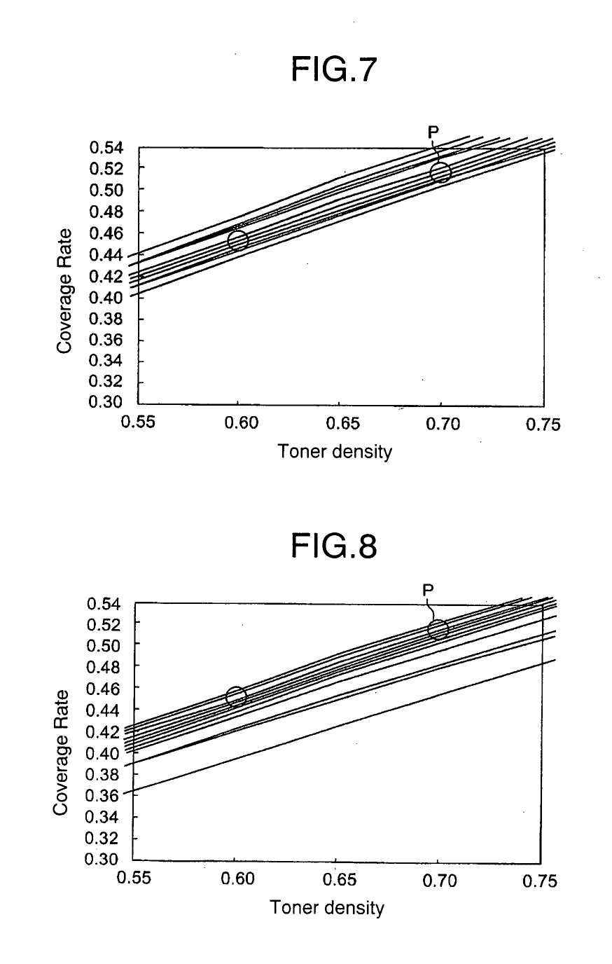

The above-mentioned image density control is executed after a prescribed number of sheets of printings by obtaining the coverage rate “CR” and corrected coverage rate “CCR” using the toner patch formed on the intermediate transfer belt 11. However, as the reflection measurements are executed many times, measured values vary, due to the differences between the image forming apparatuses, variation in the output adjustments in the toner density measurement units, setup accuracy of the toner density measurement unit and so on. The measured values becomes probably higher than a target coverage rate P as shown in FIG. 7, if the image density is controlled, on the basis of the corrected coverage rate “CCR” defined by formula (3). In this case, the image density is excessively corrected. Resultantly, the image density becomes lowered, due to an excessive control of the image forming conditions such as the development bias voltage.

Therefore, the corrected coverage rate “CCR” is further corrected by the correction rate “L”, thereby obtaining a newly corrected coverage rate “NCCR” defined by the following formula (4);
NCCR=(1+(B−1)×L)×(1−((P−P0)−(S−S0))/((Pg−P0)−(Sg−S0))) (4),
where “L” is 0.7 (70% correction), although “L” is 100% in FIG. 7.

Referring to FIG. 8, if “NCCR” as defined by formula (4) is employed, the measured values may possibly become lower than the target P (“NCCR”). Thus, the image density is not excessively corrected. Resultantly, the image density lowering is prevented by a proper control of the image forming conditions such as the development bias voltage.

Further, it is required to rewrite the formulae (1) through (4) for the coverage rate “CR”, the durability “X”, corrected coverage rate “CCR” and the newly corrected coverage rate “NCCR”. This is because in general the S polarization light intensity is lower than the P polarization light intensity, thereby lowering the measurement accuracy for detecting the S polarization light. Inversely, the measurement accuracy is improved by making the S polarization light intensity higher than it proper intensity. In this case, the correction factor “K” for the S polarization light for calculating the coverage rate “CR” should be introduced responsive to the output adjustment in the toner density measurement unit.

Thus, the formulae (1) through (4) are replaced by the following formulae (5) through (8), respectively.
CRK=1−((P−P0)−(S−S0)×K)/((Pg−P0)−(Sg−S0)×K) Formula (5):
XK=A×(1−(Sg−S0)×K/((Pg−P0)) Formula (6):,

where “A” is a constant which is determined by ((Pg−P0)−(Sg−S0)×K), when (Pg−P0)=A.
CCRK=B×(1−((P−P0)−(S−S0)×K)/((Pg−P0)−(Sg−S0)×K)) Formula (7)
NCCRK=(1+(B−1)×L)×(1−((P−P0)−(S−S0)×K)/((Pg−P0)−(Sg−S0)×K)) Formula (8)

The constant “K” is in the range of (0,1) excluding 0. “K” was 1, in the formulae (1) through (4). The experiment showed “K” is preferably 0.9, in formulae (5) through (8).

Although the preferred embodiment was explained, the preferred embodiment can be modified in several ways. All though the three color was lumped together and corrected, the correction may be independently executed for each color. Thus, more precise control of the image density can be executed by always maintaining the relation between the toner quantity and the coverage rate, even if the surface state of the intermediate transfer belt changes after long term use. Further, although the S polarization light intensity was corrected in the output power adjustment, the P polarization light intensity may be corrected in the output power adjustment.

In the present invention, the coverage rate “CR” as defined by formula (1) is obtained, the durability “X” of the toner image carrier means is defined by the formula (2) and the corrected coverage rate “CCR” is obtained by using the parameter “X”, thereby obtaining the toner density. As a result, the toner density can be always precisely obtained, on the basis of the corrected coverage rate “CCR”, even if the durability is changed. The present invention is applicable to the toner density control for copiers, printers or facsimile apparatuses.

What is claimed is:

1. An image forming apparatus provided with toner image carrier means for carrying a toner image which is transferred onto a recording medium, which includes a toner density measuring unit for measuring a toner density of toner attached on said toner image carrier means, in response to a light reflected from said toner image carrier means, when a measurement light is projected on said toner image carrier means,
said toner density measuring unit comprises:
light projection means for projecting a first polarized light on said toner image carrier means at an angle inclined to a normal direction of said toner image carrier means;
polarization separating means which is positioned at an opposite side of said light projecting means regarding said normal direction of said toner image carrier and which separates polarizations of said reflected light into said first polarization and a second polarization which is different from said first polarization;
a first and second photo-detector means for detecting the first and second polarization lights and outputting a first and second outputs;
control means for obtaining said toner density on said toner image carrier means, in response to a difference between said first output and said second output,
wherein: said first output is adjusted to be equal to said second output, when a prescribed quantity of said toner is attached on said toner image carrier means;
output dark voltages from said first and second photo-detector means are measured to be P0 and S0, respectively, after the output adjustment;
back-ground voltages from said first and second photo-detector means are measured to be Pg and Sg, respectively, when any toner is not attached on said toner image carrier means;
voltages from said first and second photo-detector means are measured to be P and S, respectively, when said toner image was formed on said toner image carrier means;
said control means calculates a coverage rate CR defined by:
CR=1−((P−P0)−(S−S0))/((Pg−P0)−(Sg−S0)),
calculates a durability X defined by:
X=A×(1−(Sg−S0)/((Pg−P0)),
calculates a corrected coverage rate CCR by using X as a parameter,
and calculates said toner density on the basis of CCR.

2. The image forming apparatus according to claim 1, wherein said CCR is defined by:
CCR=B×(1−((P−P0)−(S−S0))/((Pg−P0)−(Sg−S0))),
where B is a correction factor using X as a parameter.

3. The image forming apparatus according to claim 1, wherein an output level of said second photo-detector means is corrected by a constant K in a range of (0, 1) excluding 0, and said CR is replaced by:
CRK=1−((P−P0)−(S−S0)×K)/((Pg−P0)−(Sg−S0)×K)
and said X is replaced by:
XK=A×(1−(Sg−S0)×K/((Pg−P0))

4. The image forming apparatus according to claim 2, wherein an output level of said second photo-detector means is corrected by a constant K in a range of (0, 1) excluding 1, and said CCR is replaced by:
CCRK=B×(1−((P−P0)−(S−S0)×K)/((Pg−P0)−(Sg−S0)×K))

5. The image forming apparatus according to claim 2, wherein said CCR is further corrected by a correction rate L and said CCR is replaced by:
NCCR=(1+(B−1)×L)×(1−((P−P0)−(S−S0))/((Pg−P0)−(Sg−S0)))

6. The image forming apparatus according to claim 2, wherein an output level of said second photo-detector means is corrected by a constant K in a range of (0, 1) excluding 0, and is further corrected by a correction rate L and said CCR is replaced by NCCR said CCR is corrected by a correction rate L and said CCR is replaced by:
NCCRK=(1+(B−1)×L)×(1−((P−P0)−(S−S0)×K)/((Pg−P0)−(Sg−S0)×K))
